(19) United States
(12) Patent Application Publication
(10) Pub. No.: US 2015/0199778 A1
(43) Pub. Date: Jul. 16, 2015

(54) Method for providing Trademark Saving Service

(71) Applicant: Norsang Lama, Upper Darby, PA (US)

(72) Inventor: Norsang Lama, Upper Darby, PA (US)

(73) Assignee: Norsang Lama, Upper Darby, PA (US)

(21) Appl. No.: 14/153,027

(22) Filed: Jan. 11, 2014

(51) Int. Cl. G06Q 50/18; G06Q 20/10

(52) U.S. Cl. CPC G06Q 50/184; G06Q 20/108

(57) ABSTRACT

The present invention relates to a method of providing an extremely high quality trademark saving service for users, the present invention seeks to provide receipt saving to users by providing Viewpeer.com's “deposit trademark, withdraw cash” program comprising of service offered by Viewpeer.com. This method to provide trademark saving to users by offering “deposit trademark, withdraw cash” helps users save money with trademark where trademark becomes claim check for users to withdraw money from the bank partnered with Viewpeer.com. This sales strategy provided by Viewpeer will convert trademark into claim check for users to withdraw cash. Saving through trademark is the main key invention where users will be able to save money using trademark as a claim check.

The present invention relates to a method of providing an extremely high quality trademark saving service for users.

### BACKGROUND

Almost all the trademarks that are in the market today offer several ways to save money. Commonly we can see offers like certain percent off with the coupon, certain percent off for limited time, employee discount saving, x percent saving on special events and Employee discount saving. We have no program in the market today that provides users with the trademark saving.

### Problem 1 [trademark saving]

Trademarks today in the market have no way for users to spend trademark once purchased. There is no service or programs at all where users are allowed to spent trademark of a product or service once purchased. Trademarks we see in the market today don't provide users with any trademark that is spendable. Therefore trademark remains worthless paper with no market value with the product or service logo and print on it.

### Problem 2 [trademark spending]

Traditional advertising we see on the trademark today consists of the logo and some trademark related slogan. Users will see the ad of a product or service and buys the product or service depending on their interest. None of the trademark in the market today provides a way for users to differentiate between the trademarks that are deposit able form the trademark that are not deposit able. With the regular advertisement of trademarks of product or service we see today, doesn't provide any special sign or logo to represent if the trademark itself has the value of cash or not.

### Problem 3 [trademark advertising]

There is no single trademark in the market today that provides users, where earning while buying is possible. In addition There is no single company that provides service to users where earning while buying is possible. When a user buys the trademark, the trademark bought provides nothing in return financially to the users. Users are left with the trademark of product or service that consists of logo, prints and phrases of the trademark which of course has no market value.

### Problem 4 [trademark earning]

It would be desirable if a user could get an extremely high quality trademark saving, spending, advertising and earning which is guaranteed to be partial [without conflict of interest], which is comparable or better in price to others services, which will allow a user to save, spend, and earn freely with trademark.

### SUMMARY

The present invention seeks to provide a solution to this problem(s) by providing Viewpeer.com's “deposit trademark, withdraw cash” program comprising of service offered by Viewpeer.com, which is accepted by trademark owner. Viewpeer Service would be carried out with the trademark owner by allowing to print Viewpeer's deposit able trademark “dark turquoise with the letter ‘VP’ logo which is [symbol] ” on the product or service “trademark” of the owner ready to provide the Viewpeer.com's “deposit trademark, withdraw cash” program to the users, trademark will hit the market with “Viewpeer deposit able trademark logo [symbol] ” on the product or service “trademark” of the owner ready to provide trademark saving to the users, buyers choosing to purchase the product or service will buy the product or service that provides Viewpeer “deposit trademark, withdraw cash” program by looking for the Viewpeer's “deposit able trademark logo [symbol] ” on the trademark of a product or service of the owner. Users will also be able to browse the Viewpeer.com website to view the list of all the trademarks with their respective trademark saving amount.

Trademark with the Viewpeer.com's “deposit able trademark logo [symbol] ”on them, will have the value of currency. In other word the trademark of the owner partnered with Viewpeer.com's “deposit trademark, withdraw cash” program will have the value of currency. Product serial number will become a claim check to deposit trademark and withdraw cash. Finally, the buyers will be able to deposit trademark that provides Viewpeer.com's “deposit trademark, withdraw cash” program and will be able to save or withdraw cash at the nearest bank partnered with Viewpeer.com. Comparing to any other saving services today Viewpeer.com's “deposit trademark withdraw cash” program will enable users to save through trademark.

### Basic Embodiment Flowchart

1 service offered by Viewpeer.com is accepted by trademark owner.

2 Viewpeer.com's “deposit trademark, withdraw cash” Service would be carried out with the trademark owner by allowing to print “Viewpeer deposit able trademark logo [symbol] ” on the trademark of the owner.

3 Trademark of the Owners accepting the Viewpeer.com's “deposit trademark, withdraw cash” program will hit the market with “Viewpeer deposit able trademark logo [symbol] ” on the trademark of the Owner.

4 buyers choosing to purchase the product or service will buy the product or service simply by looking for the logo of Viewpeer.com's deposit able trademark [symbol] . If the logo is on the trademark of the owner's product or service the trademark is deposit able. If the logo is not on the trademark, the trademark is not deposit able. Users can also browse the Viewpeer.com website to receive the updates of the trademark on Viewpeer.com.

5 Finally the buyers will deposit trademark that are deposit able at the nearest bank partnered with Viewpeer.com

### Preferred Embodiment Flowchart

1 service offered by Viewpeer.com is accepted by trademark owner.

2. Viewpeer trademark associates will set up a meeting in person or phone with the trademark owner to sign the deal.

3 login accounts will be given by Viewpeer associates to trademark owner to update the trademark of the owner at Viewpeer.com

4 Trademark owners will get id number after registration process is completed on Viewpeer.com to post trademark updates.

5 Viewpeer.com and trademark owner will launch the deposit trademark, withdraw cash program together.

6 product or service hits the market with Viewpeer.com's “deposit trademark withdraw cash” program. Viewpeer will receive all the serial number of the product from the trademark owner willing to provide users with the Viewpeer.com's “deposit trademark, withdraw cash” program.

After the product or service has been taken to market users will be able to withdraw cash for the trademark.

7 Viewpeer will charge the trademark owner for the Viewpeer.com's “deposit trademark, withdraw cash” service per every product or service sold.

### DETAIL DESCRIPTION

Viewpeer.com provides users with new way of saving by providing “deposit trademark withdraw cash” program. Trademark of a product or a service partnered with Viewpeer.com's “deposit trademark withdraw cash” program will allow users to cash in trademark because Viewpeer.com partner trademark will have a value of currency.

### Problems Mirrored

Almost all the trademarks that are in the market today offer several ways to save money. Commonly we can see offers like certain percent off with the coupon, certain percent off for limited time, employee discount saving, x percent saving on special events and Employee discount. We have no program in the market today that provides users with the trademark saving. Viewpeer.com's approach to this problem is simple. Viewpeer.com's “deposit trademark, withdraw cash” program allows users to save money from the trademark itself. Once the product or service hits the market with Viewpeer.com's “deposit able trademark logo [symbol] ” the trademark of the product or service will have the value of the currency, after the agreement is signed with Viewpeer.com by trademark owner to provide “deposit trademark, withdraw cash” program to users. Which means users can only deposit the trademark of the product or service to the bank if the trademark is partnered with Viewpeer.com. The way to find out if the trademark is partnered with Viewpeer.com's “deposit trademark, withdraw cash” program or not is by logging in to Viewpeer.com to search for the trademark. Trademark of the owner partnered with Viewpeer.com, will become a claim check to save or withdraw money claimed on the trademark by trademark owner at the bank partnered with Viewpeer.com. Worth of a trademark will be varied depending on the trademark owner's will. With Viewpeer.com's “deposit trademark, withdraw cash” program, users can add different trademarks to their asset not liability, because the trademark will be deposit able. The trademark saving problem will be solved through this Viewpeer.com's “deposit trademark, withdraw cash” program. Suppose a trademark owner wants to apply “deposit trademark, withdraw cash” program on his trademark, Viewpeer.com will allow trademark owners to print “deposit able trademark logo on his product to let consumers know that particular product is providing trademark saving to consumers. By having “deposit, trademark logo on the product or service, customers will now be aware that the product is with “deposit trademark, withdraw cash program and provides saving to them. Now that the consumers are aware that trademark saving with deposit trademark withdraw cash program next question to ask is how much trademark saving? Let us assume that trademark owner of product ‘A’ or Service “1′ provides amount of $2.50 per trademark as “deposit trademark, withdraw cash” program to the consumers for buying his product. $2.50 is the “deposit trademark withdraw cash “saving amount to consumers per trademark. Users will be able to find the amount by browsing Viewpeer.com. The trademark saving amount provided by the owner to users will be published on Viewpeer.com. The product now will hit the market with “deposit able trademark logo and to find out the worth of the trademark users will have to logon to Viewpeer.com to find the trademark saving amount. This way consumer will be able to figure two things out. First is that the product is providing them with Viewpeer.com's “Deposit trademark, withdraw cash” saving and the second the amount they can save by purchasing product or service from that trademark owner. The trademark saving amount will be provided on Viewpeer.com for each product and service by trademark owner for users. Once the trademark is bought by users from the stores providing “deposit trademark, withdraw cash” program. Users will receive the serial number of the product of that trademark. That serial number will be the claim check for users to deposit or withdraw the amount claimed by trademark owner to nearest bank partnered with Viewpeer.com

### Problem 1 Mirrored [trademark saving]

Trademarks today in the market have no way for users to spend trademark once purchased. There is no program at all where users are allowed to spent trademark. Trademarks we see in the market today don't provide users with any trademark that is spendable. Therefore trademark remains worthless paper with printed pictures and letters on it. Viewpeer.com's “deposit trademark withdraw cash” program provides service to users to withdraw cash after the trademark has been deposited which means that the users can actually save and withdraw cash. Cash are accepted everywhere, thus Viewpeer.com's “deposit trademark, withdraw cash” program solves the trademark spending problem by enabling users to deposit and withdraw trademark. This program will change trademark into deposit able trademark. The serial number of the product or service will become claim check which users should have in order to deposit trademark or withdraw cash. Once Viewpeer trademark associates receives the serial number of the product, users can withdraw cash off of the trademark providing “deposit, trademark, withdraw cash” program. Now that the users have serial number of the product they can withdraw cash or deposit cash. This process will change trademark into cash, but only of the trademark enrolled with Viewpeer.com's “deposit trademark, withdraw cash” program. When cash is being issued users are able to spend it anywhere freely. Therefore Trademark spending problem is solved through Viewpeer.com's “deposit trademark, withdraw cash” program.

### Problem 2 mirrored [Trademark spending]

Traditional advertising we see on the trademark today consists of the logo and some trademark related slogan. Users will see the ad of a product or business and buys the product depending on their interest. None of the trademark in the market today provides a way for users to differentiate between the trademarks that are deposit able form the trademark that are not deposit able. With the regular advertisement of trademarks we see today, doesn't provide any special sign or logo to represent if the trademark itself has the value of cash or not. Viewpeer.com solves this problem by printing “Viewpeer deposit able trademark logo” on the trademark of the owner providing Viewpeer.com's “deposit trademark, withdraw cash” program. If the product consists of “Viewpeer deposit able trademark logo [symbol] ”, the trademark is deposit able. If the trademark doesn't consist of the “Viewpeer deposit able trademark [symbol] ” the trademark of the owner is not deposit able. This is how Viewpeer.com will solve the trademark advertising problem.

### Problem 3 mirrored [trademark advertising]

There is no single trademark in the market today that provides users, where earning while buying is possible. In addition There is no single company that provides service to users where earning while buying is possible. When a user buys the trademark, the trademark bought provides nothing in return financially to the users. Users are left with the trademark that consists of logo, prints and phrases of the trademark which of course has no market value. Viewpeer.com provides services to users where earning while buying will be possible. Viewpeer.com will have trademark earning programs within “deposit trademark withdraw cash” program. They are Mega Trademark, mini trademark, state trademark, county trademark and super trademark. Each week Viewpeer.com will draw product number to give out money for the user with the trademark number drawn. Not only users can save money from Viewpeer.com' “deposit trademark withdraw cash” program, but will also be able to earn from Mega Trademark, mini trademark, state trademark, county trademark and super trademark program.

### Problem 4 mirrored [trademark earning]

The present invention will now be more particularly described, with reference to the Accompanying drawings, by way of example only and in no way limiting the scope of the Invention, in which:

### BRIEF DESCRIPTION OF THE DRAWINGS

FIG. 1 is a flowchart of a basic embodiment of a method for providing trademark saving service through the Viewpeer.com's “deposit trademark withdraw cash” program in accordance with the present invention; and FIG. 2 is a flowchart of a preferred embodiment of the method for providing trademark saving service through the Viewpeer.com's “deposit trademark withdraw cash” program.

### DETAILED DESCRIPTION (Basic Flowchart)

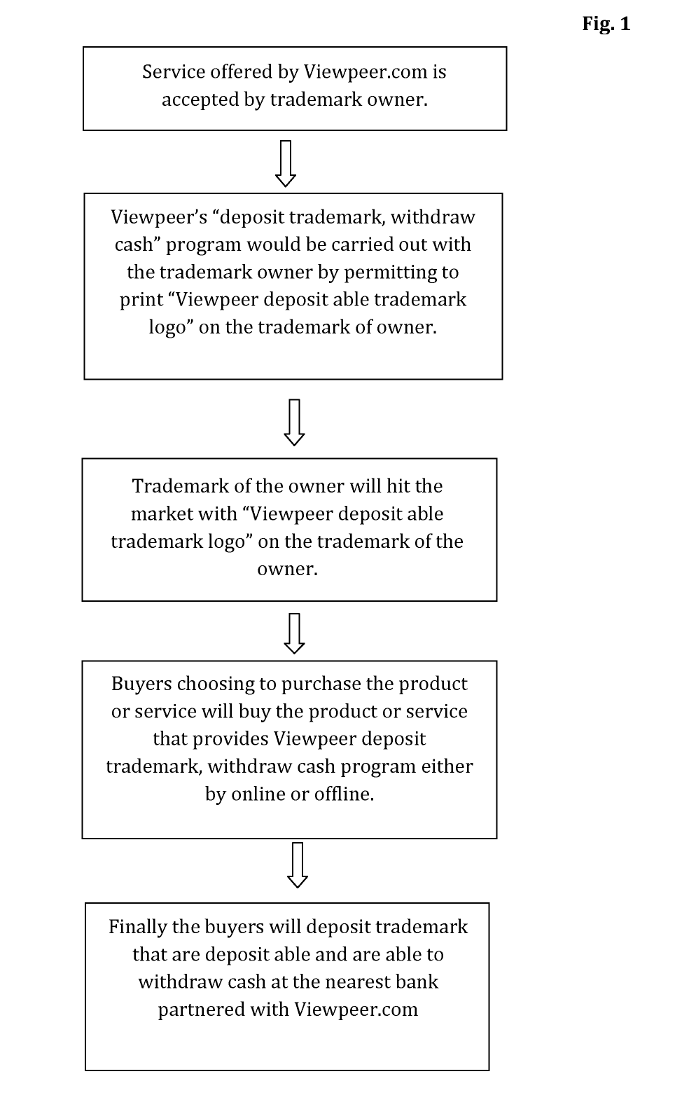

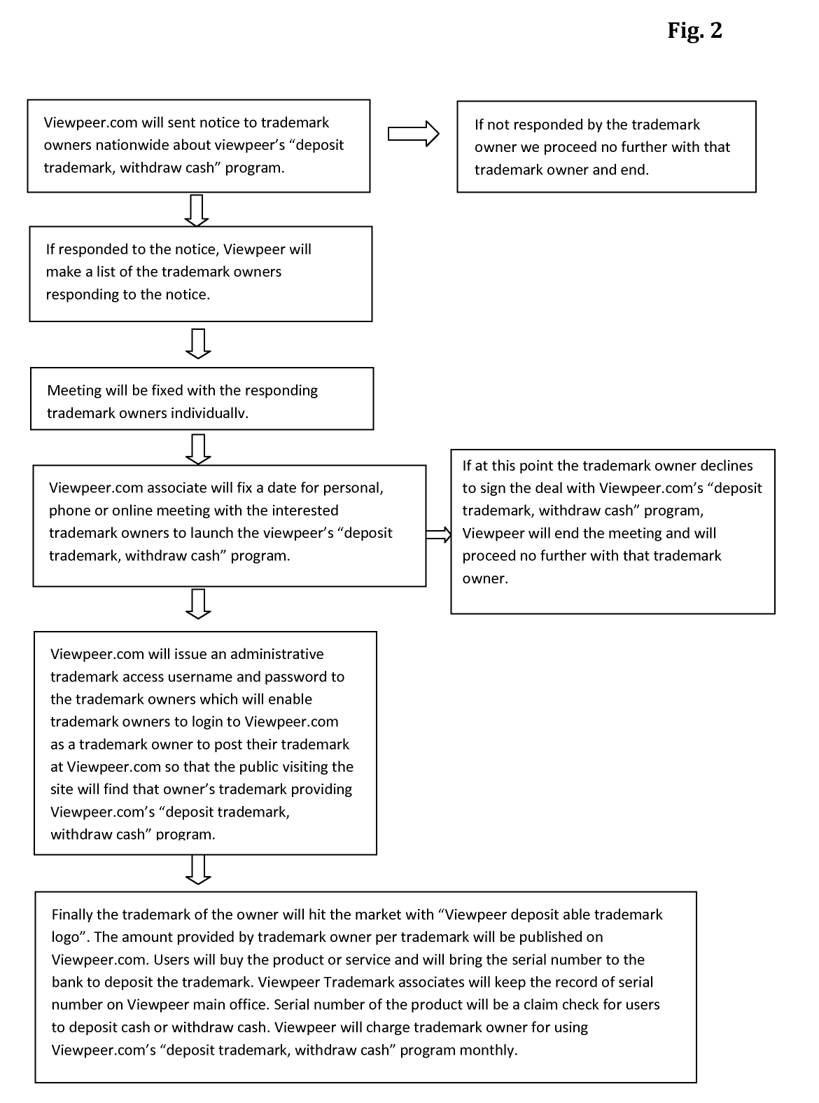

Referring to FIG. 1, there is shown a basic flowchart of the method for providing trademark saving service through the Viewpeer.com's “deposit trademark withdraw cash” program in a basic embodiment.

“Deposit trademark, withdraw cash” Service offered by Viewpeer.com is accepted by trademark owner preferably via computer through email, in person or online form. The process of enrolment could be done through telephone or in person. Any communication method can be used for setting up an appointment and to cut the deal.

Viewpeer Service would be carried out with the trademark owners by allowing to print “Viewpeer deposit able trademark [symbol] logo” next to the trademark of owner preferably by trademark owners and Viewpeer.com. Information could be outsourced to third party partnered bank.

Owner's trademark will hit the market with “Viewpeer deposit able trademark logo [symbol] ” on the trademark of owner preferably after the agreement is done between trademark owner and Viewpeer.com.

Buyers choosing to purchase the product or service will buy the product or service that provides Viewpeer.com's “deposit trademark, withdraw cash” program from the store or store.

then the buyers will deposit trademark and are able to withdraw cash at the nearest bank partnered with Viewpeer.com preferably Payment received only after buyers buy the product or service from trademark owner partnered with Viewpeer.com's deposit trademark withdraw cash program.

### DETAILED DESCRIPTION OF THE PREFERRED EMBODIMENT FLOWCHART

Referring to FIG. 2, there is shown a flowchart of the method for providing trademark saving service through the Viewpeer.com's “deposit trademark withdraw cash” program in a preferred embodiment of the invention Viewpeer.com will sent notice to trademark owners nationwide about Viewpeer.com's “deposit trademark, withdraw cash” program.

If not responded by the trademark owner we proceed no further with that trademark owner and end.

If responded to the notice, Viewpeer will make a list of the trademark owners responding to the notice.

Meeting will be fixed with the responding trademark owners individually via phone, internet, live chat, email or private mail.

Viewpeer.com associate will fix a date for personal, phone or online meeting with the interested trademark owners to launch the Viewpeer.com's “deposit trademark, withdraw cash” program and to fix the date to launch owners trademark.

If at this point the trademark owner declines to sign the deal with Viewpeer.com's “deposit trademark, withdraw cash” program, Viewpeer will end the meeting and will proceed no further with that trademark.

Viewpeer.com will issue an administrative trademark access username and password to the trademark owners which will enable trademark owners to login to Viewpeer.com as a trademark owner to post their trademark at Viewpeer.com so that when the public comes to the site to find which trademarks are providing the “Viewpeer.com's deposit trademark, withdraw cash” program, users will find them on Viewpeer.com.

Finally the trademark will hit market with the “Viewpeer deposit able trademark logo [symbol] ” where the logo is a representation of the deposit able trademark bearing the value of the currency. Users will then have to login to Viewpeer.com to find out the amount for the trademark saving on Viewpeer.com by searching the trademark online by Viewpeer trademark id. Updates of the trademark will be posted by trademark owner on Viewpeer.com. Trademark owner will be charged accordingly for using Viewpeer.com's “deposit trademark, withdraw cash” program.

The embodiments described above are provided by way of example only, and various other modifications will be apparent to persons skilled in the art.

I claim I am the inventor of the “method for providing trademark saving service” through http://www.viewpeer.com's “deposit trademark, withdraw cash” program:

1. The present invention relates to a method of providing an extremely high quality trademark saving service for users.
